(19) United States
(12) Patent Application Publication
(10) Pub. No.: US 2025/0358313 A1
(43) Pub. Date: Nov. 20, 2025

(54) MITIGATION OF RANSOMWARE ATTACKS

(71) Applicant: Advanced Micro Devices, Inc., Santa Clara, CA (US)

(72) Inventors: Kevin Immanuel GUBBI, Austin, TX (US); Brandon Cellic WOOLLEY, Austin, TX (US); Karthik RAO, Austin, TX (US)

(21) Appl. No.: 19/287,629

(22) Filed: Jul. 31, 2025

Related U.S. Application Data
(63) Continuation-in-part of application No. 18/609,489, filed on Mar. 19, 2024, now abandoned.

(51) Int. Cl. H04L 9/40

(52) U.S. Cl. CPC H04L 63/1466

(57) ABSTRACT

Methods and circuits provide mitigation against ransomware attacks by sampling one or more physical characteristics of a semiconductor device while a ransomware attack is underway. Based on the samples taken during the ransomware attack, the key used in the ransomware attack can be extracted by performing side channel analysis.

### CROSS REFERENCE TO RELATED APPLICATION

This Application is a continuation-in-part of U.S. Non-Provisional application Ser. No. 18/609,489, filed on Mar. 19, 2024, the entire disclosure of which is incorporated herein by reference.

### TECHNICAL FIELD

The disclosure generally relates to responding to ransomware attacks.

### BACKGROUND

Ransomware is software that maliciously encrypts data on a system to which an attacker has gained access. The attacker possesses the key for decrypting the data and typically will demand payment in return for decrypting the user's data.

Detecting and recovering from ransomware attacks can be difficult. Some detection mechanisms monitor for the writing of encrypted data to storage systems. However, distinguishing between ransomware-encrypted data and legitimately encrypted data may not be feasible. Ransomware attacks may often target a backup storage system, by either encrypting or deleting the backup data, before encrypting data in primary storage. Options for recovering from a ransomware attack may be limited if backup data is unavailable.

### BRIEF DESCRIPTION OF THE DRAWINGS

Various aspects and features of the disclosed methods and systems will become apparent upon review of the following detailed description and upon reference to the drawings in which:

FIG. 1 shows a block diagram of an electronic device;

FIG. 2 shows an exemplary system for detecting a ransomware attack and extracting a ransomware key; and

FIG. 3 is a flowchart of an exemplary process for mitigating the effects of a ransomware attack.

### DETAILED DESCRIPTION

In the following description, numerous specific details are set forth to describe specific examples presented herein. It should be apparent, however, to one skilled in the art, that one or more other examples and/or variations of these examples, all of which are non-limiting, may be practiced without all the specific details given below. In other instances, well known features have not been described in detail so as not to obscure the description of the examples herein. For ease of illustration, the same reference numerals may be used in different diagrams to refer to the same elements or additional instances of the same element.

The disclosed approaches support mitigation at the time a ransomware attack begins without requiring external components for detection or mitigation. The mitigation mechanism, which can be implemented as hardware or firmware, operates in real-time on an electronic device. As an example, during a ransomware attack encryption operations are activated, which can cause variations in physical characteristics of the system-on-chip (SoC). Examples of the physical characteristics include, for example, voltage, clock signal frequency, electromagnetic radiation, and temperature. According to the disclosed circuits and methods, management circuitry on a system-on-chip (SoC), or equivalently, a system-in-package (SiP), samples one or more of the physical characteristics of the SoC while a ransomware attack is underway. Key extractor logic performs side channel analysis of the sampled data to recover the keys used in the ransomware attack. Once the keys have been recovered, the data encrypted by the ransomware can be recovered without assistance from the attacker.

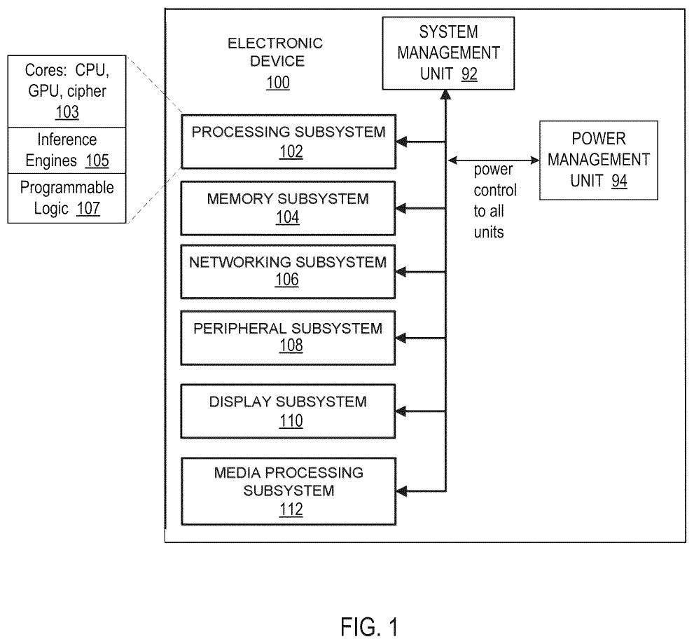

FIG. 1 shows a block diagram of an electronic device 100. Electronic device 100, which can be implemented as an SoC, includes system management unit (SMU) 92, power management unit (PMU) 94, processing subsystem 102, memory subsystem 104, networking subsystem 106, peripheral subsystem 108, display subsystem 110, media processing subsystem 112. Generally, processing subsystem 102, memory subsystem 104, networking subsystem 106, peripheral subsystem 108, display subsystem 110, media processing subsystem 112 (“the subsystems”) are implemented in hardware, i.e., using various circuit elements and devices. For example, some or all of the subsystems can be entirely fabricated on one or more semiconductor chips, can be fashioned from semiconductor chips in combination with discrete circuit elements, etc.

SMU 92 is a local controller that controls the operation of the resources on device 100 and synchronizes communication among them. SMU 92 manages power-up sequencing of the various processors on device 100 and controls multiple off-chip devices via reset, enable and other signals. SMU 92 includes one or more clock sources (not shown), such as a phase locked loop (PLL), to provide clock signals for each of the components of device 100. Through PMU 94, SMU 92 manages power for the various subsystems, and may receive measured power consumption values from the subsystems to determine appropriate power states.

PMU 94 communicates commands, information, and/or other requests to the subsystems in order to set one or more operating parameters such as clock frequencies and power supply voltages. Additionally, PMU 94 monitors power usage of the subsystems and provides telemetry such as frequency, power state, overall power consumption, temperature, etc. to the SMU 92.

Processing subsystem 102 is a circuit block that is configured to perform computational operations (e.g., instruction execution, data processing, etc.), control operations, event handling operations, and/or other operations. For example, processing subsystem 102 may include various processor cores 103, such as one or more central processing units (CPUs), graphics processing units (GPUs), and one or more cipher circuit blocks. The processor subsystem can also include inference engines 105 and/or programmable-logic 107.

The CPU cores perform general data processing. The GPU cores can perform graphics operations such as vector processing, fragment processing, shading, texture blending, and the like in a highly integrated and parallel fashion.

The cipher circuit blocks can be implemented by microprocessors or programmable logic configured to perform designated encryption and decryption operations.

The inference engine 105 can be implemented as an array of data processing engines (DPE). Each DPE can include a program memory and a processor configured to execute program code from the memory. The DPEs in the array can be communicatively coupled such that data generated by one DPE can be input for further processing to an adjacent DPE in the array.

The programmable logic 107 includes circuitry that can be configured to perform specified functions. For example, the programmable logic can be implemented as a field programmable gate array (FPGA), which includes an array of programmable circuit blocks. Examples of programmable circuit blocks include, but are not limited to, configurable logic blocks (CLBs), dedicated random access memory blocks (BRAM and/or UltraRAM or URAM), digital signal processing blocks (DSPs), clock managers, and/or delay lock loops (DLLs).

Memory subsystem 104 is a circuit block that is configured to store data and/or instructions for access by the other subsystems in electronic device 100 and perform operations for providing the other subsystems to access to the data and/or instructions. In some embodiments, memory subsystem 104 includes volatile memory circuits such as dynamic random access memory (DRAM), static random access memory (SRAM), and/or other types of memory that are used for storing the instructions and data, as well as mechanisms for controlling the memory circuits. In some embodiments, memory subsystem 104 includes a memory hierarchy with one or more caches and a main memory (processing subsystem 102 may also include one or more caches).

In some embodiments, memory subsystem 104 is coupled to one or more non-volatile high-capacity mass-storage devices (not shown). For example, memory subsystem 104 can be coupled to a magnetic or optical disk drive, a solid-state drive, or another type of mass-storage device. In these embodiments, memory subsystem 104 can be used by electronic device 100 as fast-access storage for more frequently/recently used data, while the mass-storage device is used to store less frequently/recently used data.

Networking subsystem 106 is a circuit block that is configured to couple to and communicate on one or more wired and/or wireless networks. For example, networking subsystem 106 can include one or more of a Bluetooth networking system, a cellular networking system (e.g., a 4G network such as LTE), a universal serial bus (USB) networking system, a networking system based on the standards described in Institute for Electrical and Electronics Engineers (IEEE) 802.11, 802.15, etc. (e.g., a Wi-Fi networking system), an Ethernet networking system, and/or another networking system. Networking subsystem 106 includes processors, controllers, radios/antennas, sockets/plugs, and/or other devices used for coupling to, communicating on, and handling data and events for each supported networking system. In the following description, the mechanisms used for coupling to, communicating on, and handling data and events on the network for each network system are referred to collectively as the “interface” or “network interface” for the network system.

Peripheral subsystem 108 is a circuit block that performs operations relating to interfacing electronic device 100 with peripheral devices such as keyboards, mice, scanners, microphones, etc. Peripheral subsystem 108 includes connectors (plugs, sockets, etc.) and controllers for connecting to, receiving information (e.g., interrupts/requests, data, messages, etc.) from, and sending information to peripherals that are connected to electronic device 100.

Display subsystem 110 is a functional block that performs operations relating to presenting information on a display (e.g., a display screen). Display subsystem 110 includes connectors (e.g., sockets, plugs, etc.) and controllers for receiving information to be shown on the display from other subsystems in electronic device 100 and providing the information to the display to be presented thereon. In some embodiments, display subsystem 110 receives information from a touch screen display and handles the information, such as by forwarding the received information to processing subsystem 102 or other subsystems.

Media processing subsystem 112 is a functional block that performs operations relating to processing media for display on the display of electronic device 100, output via one or more speakers coupled to electronic device 100, and/or for another form of presentation (e.g., haptic, etc.). For example, media processing subsystem 112 may decode audio and/or video, render information for presentation, and/or perform other media processing functions.

In some embodiments, communication paths (that include one or more buses, wires, guides, and/or connections) are coupled between the subsystems in electronic device 100 (e.g., processing subsystem 102, memory subsystem 104, etc.), as shown by arrow-headed lines between the elements. The communication paths are used to transmit commands, data, and/or other information between the elements.

Although specific subsystems are shown in electronic device 100, in some embodiments, different subsystems and/or components may be included in electronic device 100. For example, electronic device 100 may include one or more additional processing subsystems 102, memory subsystems 104, etc. Additionally, one or more of the subsystems may not be included in electronic device 100, or some or all of the one or more of the subsystem's functions may be incorporated into the other subsystems. In addition, although electronic device 100 is simplified for illustrative purposes, in some embodiments, electronic device 100 includes additional or different subsystems, functional blocks, elements, and/or communication paths. For example, electronic device 100 may include power subsystems, I/O subsystems, etc. Generally, electronic device 100 includes sufficient subsystems to perform the operations herein described.

Electronic device 100 can be, or can be included in, any device that performs computational operations. For example, electronic device 100 can be, or can be included in, a desktop computer, a laptop computer, a wearable computing device, a tablet computer, a piece of virtual or augmented reality equipment, a smart phone, an artificial intelligence (AI) device, a server, a network appliance, a toy, a piece of audio-visual equipment, a home appliance, a vehicle, etc., and/or combinations thereof.

According to the disclosed approaches, the device 100 can include logic that can detect a ransomware attack and respond to the attack by collecting side channel data and extracting the attack keys through side channel analysis. The logic can be implemented by program code for the cores 103, inference engines 105 and/or configuration of the programmable logic 107, with support from the SMU 92 and PMU 94 (or a driver of an external probe). The methods and circuits can support analysis by sampling physical characteristics (or “side channel data”) of the SoC such as voltage, clock signal frequency, electromagnetic radiation, and temperature. According to an alternative approach, the key extractor circuitry can be external the SoC and respond to a signal from detection circuitry on the SoC indicating a ransomware attack is underway.

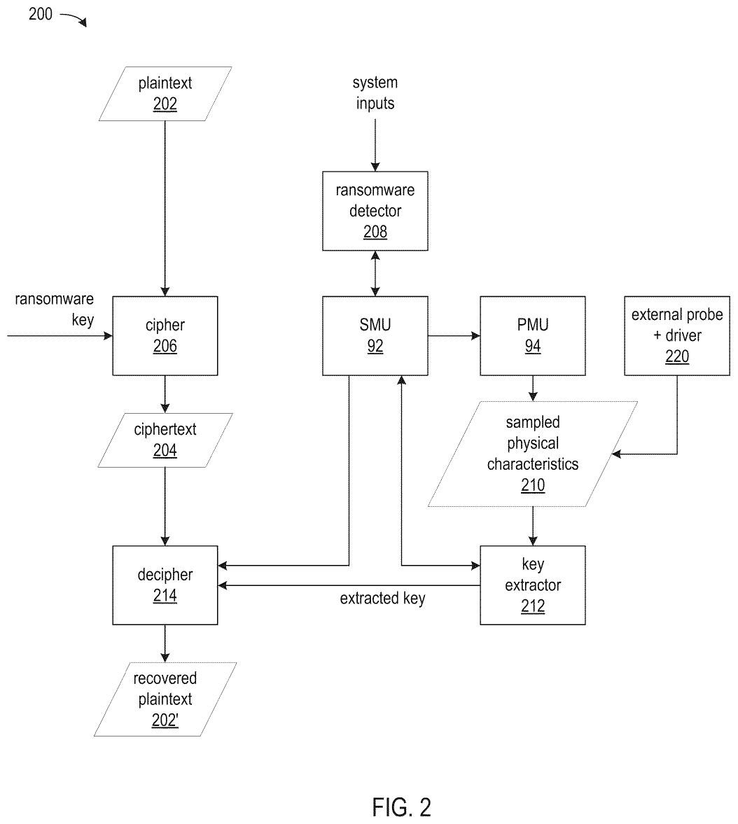

FIG. 2 shows an exemplary system for detecting a ransomware attack and extracting a ransomware key. During a ransomware attack, plaintext data files 202 that are accessible in the system 200 are encrypted into cipher text 204 by cipher logic 206 beginning with an input ransomware key. Cipher logic may be software executing on a CPU core or a dedicated circuit block of the SoC, depending on the system architecture.

System 200 includes ransomware detector logic 208, which can be activated by SMU 92 once the system has booted. Ransomware detector logic 208 can be implemented by software executing on CPU and/or GPU cores 103 (FIG. 1) or on an inference engine 105. The ransomware detector logic 208 can implement one or more known mechanisms for detecting an attack based on various system inputs. For example, the detection logic can implement a signature-based approach, detection of abnormal file executions (e.g., renaming of files), and/or surveying the system for traffic to/from suspicious file-sharing sites. The various approaches can employ machine learning models and techniques to identify patterns indicative of a ransomware attack.

In conjunction with starting ransomware detector logic 208 once the system is booted, management logic can also be started to immediately begin sampling physical characteristics of the SoC. In a departure from prior approaches, mitigation actions may be taken while a ransomware attack is underway but not yet detected. A ransomware attack usually inhibits or stops regular system functions, thereby delaying mitigation actions of prior methods until the attack is complete. According to one embodiment, PMU 94 can accumulate sampled physical characteristics 210 in a circular buffer in the memory subsystem (FIG. 1, 104) without first being triggered by SMU 92. The sampled physical characteristics of the SoC by PMU 94 or by another component of the SoC can include side channel data such as voltage levels, clock signal frequencies, electromagnetic radiation levels, and/or temperatures.

According to an exemplary SoC and to support sampling of levels of electromagnetic radiation (EMR), an external probe 220 can be disposed proximate the SoC. A hardware low-pass filter can be coupled to the probe and provide the data as input to a driver executing on the CPU/core of the SoC via an input/output channel (e.g., USB, PCIe, 12C, SPI etc.). The driver can collect and buffer the sampled EMR data into a circular buffer in the memory subsystem (FIG. 1, 104).

In response to detecting an in-progress ransomware attack, detector logic 208 signals SMU 92 that an attack is underway, and in turn SMU 92 signals PMU 94 (or driver of the external probe 220). In response to the signaling of the ransomware attack, PMU 94/driver can preserve the current state of the buffer(s), and allocate memory to store subsequently sampled side channel data.

SMU 92 can signal key extractor logic 212 to commence key extraction, and PMU 94 or driver can communicate to key extractor logic 212 the location in the circular buffer at which to being analyzing the sampled data. Key extractor logic 212 can be implemented by software executing on CPU and/or GPU cores 103 (FIG. 1), by inference engines 105, by programmable logic 107, or as a static logic circuit of the SoC, for example. In an alternative approach, key extractor logic 212 can be implemented by circuitry external (off-SoC) to the device 100. In an implementation in which power characteristics are sampled, key extractor logic 212 can be configured to perform differential power analysis (DPA) or correlative power analysis (CPA) of the sampled side channel data to recover the ransomware key. Key extractor logic 212 can be configured to employ one or more machine learning models to extract the key.

Key extractor logic 212 signals SMU 92 in response to extraction of the ransomware key, and in response, SMU 92 signals decipher logic 214 to commence decryption using the extracted key. Decipher logic 214 may be software executing on a CPU core or a dedicated circuit block of the SoC, depending on the system architecture. Decipher logic 214 inputs ciphertext 204 and decrypts the data into recovered plaintext 202′ using the extracted key.

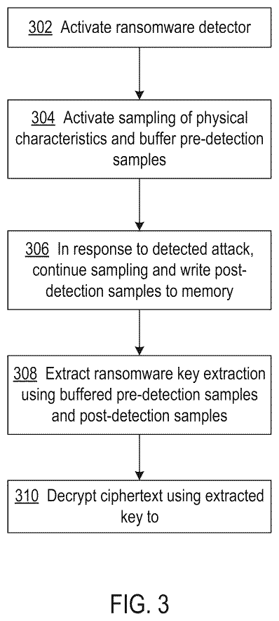

FIG. 3 is a flowchart of an exemplary process for mitigating the effects of a ransomware attack. At blocks 302 and 304 ransomware mitigation components are activated. The ransomware detector logic is activated at block 302, and management logic for sampling physical characteristics of the SoC is activated at block 304. According to one approach, the components are activated as of part booting the SoC. The sampled physical characteristics can include, for example, voltage levels, clock signal frequencies, electromagnetic radiation levels, and/or temperatures. Voltage levels, temperatures, and/or clock signal frequencies can be sampled by a PMU, for example. Sampling levels of EMR can be supported by an external probe disposed proximate the SoC and a low-pass filter coupled to the probe. Samples of EMR levels can be provided as input data to a driver executing on the CPU/core of the SoC via an input/output channel (e.g., USB, PCIe, 12C, SPI etc.). Prior to detection of a ransomware attack and while the ransomware detector logic monitors the SoC for indications of an attack, the PMU or driver can collect and buffer data representing pre-detection samples into a circular buffer in a memory of the SoC.

A ransomware attack can be detected by software executing on CPU and/or GPU cores of the SoC and/or by an inference engine of the SoC using one or more known mechanisms. For example, a ransomware attack can be detected using a signature-based approach, monitoring for abnormal file executions (e.g., renaming of files), and/or surveying the system for traffic to/from suspicious file-sharing sites. The various approaches can employ machine learning models and techniques to identify patterns indicative of a ransomware attack.

At block 306, in response to the ransomware detector logic signaling an attack is underway, such as through an interrupt signal or writing a value to a shared memory, the management logic can store the address/location in the circular buffer at which the last pre-detection sample was written. Using recognized memory management, the management logic can allocate memory for storing physical characteristics sampled after detection of the attack, either in response to detection of the attack or at SoC boot time, depending on application objectives. After being alerted to a ransomware attack, the management logic stores the post-detection samples of the physical characteristics in the allocated memory space in order to preserve the pre-detection samples in the circular buffer for analysis. The circular buffer and memory space allocated for storing the post-detection samples can be implemented in the same physically addressable RAM or in separate physically addressable RAMs.

Additionally, responsive to the ransomware detector logic signaling an attack is underway, at the block 308 the key extractor logic begins side channel analysis of the sampled physical characteristics. The key extractor logic begins analysis with the pre-detection samples in the circular buffer, which are followed by the post-detection samples in the allocated memory. The key extractor logic can be implemented by program code for CPU/GPU cores, inference engines and/or configuration of the programmable logic of the SoC. In an implementation in which power characteristics are sampled, the key can be extracted by performing differential power analysis (DPA) or correlative power analysis (CPA) of the sampled side channel data to recover the ransomware key using recognized techniques. For example, machine learning models can be used to extract the key.

At block 310, a decryption process decrypts the ciphertext generated by the ransomware using the ransomware key extracted by the key extractor logic. The decryption process can be implemented by software executing on a CPU core or a dedicated circuit block of the SoC, depending on the system architecture.

Various logic may be implemented as circuitry to carry out one or more of the operations and activities described herein and/or shown in the figures. In these contexts, a circuit or circuitry may be referred to using terms such as “logic,” “module,” “engine,” “unit,” “generator,” or “block.” It should be understood that elements labeled by these terms are all circuits that carry out one or more of the operations/activities. In certain implementations, a programmable circuit is one or more computer circuits programmed to execute a set (or sets) of instructions stored in a ROM or RAM and/or operate according to configuration data stored in a configuration memory.

Though aspects and features may in some cases be described in individual figures, it will be appreciated that features from one figure can be combined with features of another figure even though the combination is not explicitly shown or explicitly described as a combination.

The methods and circuitry are thought to be applicable to a variety of systems for mitigating the effects of ransomware attacks. Other aspects and features will be apparent to those skilled in the art from consideration of the specification. The methods and circuitry may be implemented as one or more processors configured to execute software, as an application specific integrated circuit (ASIC), or as a logic on a programmable logic device. It is intended that the specification and drawings be considered as examples only, with a true scope of the invention being indicated by the following claims.

What is claimed is:

1. A method comprising:
sampling, using management circuitry of a semiconductor device, one or more physical characteristics of the device while a ransomware attack is underway; and
extracting a key used in the ransomware attack, by a key extractor circuit performing side channel analysis on samples of the one or more physical characteristics.

2. The method of claim 1, wherein:
the sampling includes sampling the one or more physical characteristics of the semiconductor device as pre-detection samples before detection of the ransomware attack, and sampling the one or more physical characteristics of the semiconductor device as post-detection samples after detection of the ransomware attack; and
the extracting includes performing side channel analysis on the pre-detection samples and the post-detection samples.

3. The method of claim 2, wherein storing the pre-detection samples includes maintaining a circular buffer of the pre-detection samples.

4. The method of claim 1, further comprising initiating the sampling in response to a signal that indicates the ransomware attack.

5. The method of claim 1, wherein the sampling includes sampling by a management circuit on the semiconductor device.

6. The method of claim 1, wherein the sampling includes sampling electromagnetic radiation emitted by the semiconductor device.

7. The method of claim 1, wherein the key extractor circuit is on the semiconductor device.

8. The method of claim 1, wherein extracting the key includes inference processing of the one or more physical characteristics using a machine learning model.

9. The method of claim 1, further comprising detecting the ransomware attack and generating a signal that indicates the ransomware attack.

10. The method of claim 1, wherein the one or more physical characteristics include one or more of a voltage level, frequency of a clock signal, temperature, and a level of electromagnetic radiation.

11. A circuit arrangement comprising:
a management circuit configured to sample one or more physical characteristics from a semiconductor device while a ransomware attack is underway; and
a key extractor circuit coupled to receive samples of the one or more physical characteristics and configured to extract a key used in the ransomware attack by performing side channel analysis on the samples.

12. The circuit arrangement of claim 11, wherein:
the management circuit is configured to sample the one or more physical characteristics of the semiconductor device as pre-detection samples before detection of the ransomware attack, and sample the one or more physical characteristics of the semiconductor device as post-detection samples after detection of the ransomware attack; and
the key extractor circuit is configured to perform side channel analysis on the pre-detection samples and the post-detection samples.

13. The circuit arrangement of claim 12, wherein the management circuit is configured to maintain a circular buffer of the pre-detection samples.

14. The circuit arrangement of claim 11, wherein the management circuit is configured to initiate sampling in response to a signal that indicates the ransomware attack is underway.

15. The circuit arrangement of claim 11, wherein the management circuit is disposed on the semiconductor device.

16. The circuit arrangement of claim 11, wherein the key extractor circuit is disposed on the semiconductor device.

17. The circuit arrangement of claim 11, wherein the key extractor circuit is configured to perform inference processing of the one or more physical characteristics using a machine learning model trained for side channel analysis.

18. The circuit arrangement of claim 11, further comprising detection circuitry disposed on the semiconductor device and configured to detect the ransomware attack and generate a signal that indicates the ransomware attack is underway.

19. The circuit arrangement of claim 18, wherein the detection circuitry implements a machine learning model.

20. The circuit arrangement of claim 11, wherein the one or more physical characteristics include one or more of a voltage level, frequency of a clock signal, temperature, and a level of electromagnetic radiation.
